(19) United States
(12) Patent Application Publication
(10) Pub. No.: US 2005/0205605 A1
(43) Pub. Date: Sep. 22, 2005

(54) Illuminated liquid soap dispenser

(76) Inventor: Edward O. Clapper, Tempe, AZ (US)

Correspondence Address: RICHARD C. CALDERWOOD, 2775 NW 126TH AVE, PORTLAND, OR, 97229-8381, US

(21) Appl. No.: 10/847,727

(22) Filed: May 17, 2004

Related U.S. Application Data
(60) Provisional application No. 60/549,000, filed on Feb. 28, 2004.

(51) Int. Cl. B67D 5/08

(52) U.S. Cl. 222/113; 222/321.9

(57) ABSTRACT

An illuminated, translucent dispenser for liquid soap. Illumination is provided by an electric lamp embedded within or beneath the liquid. The illumination means may be part of the dispenser or a base upon which the dispenser can be placed. The illumination means may be battery-powered. In one embodiment, the dispenser is configured as a night-light.

### RELATED APPLICATION

Under 35 USC 119(e), this application claims benefit of the filing date of provisional application No. 60/549,000 filed Feb. 28, 2004 by this inventor.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 and Section I show one embodiment of an illuminated soap dispenser according to the invention with the soap receptacle configured to accommodate a light emitting apparatus within its volume.

FIG. 2 and Section II show another embodiment of an illuminated soap dispenser where the receptacle is a conventional container resting on a light-emitting base.

### DETAILED DESCRIPTION

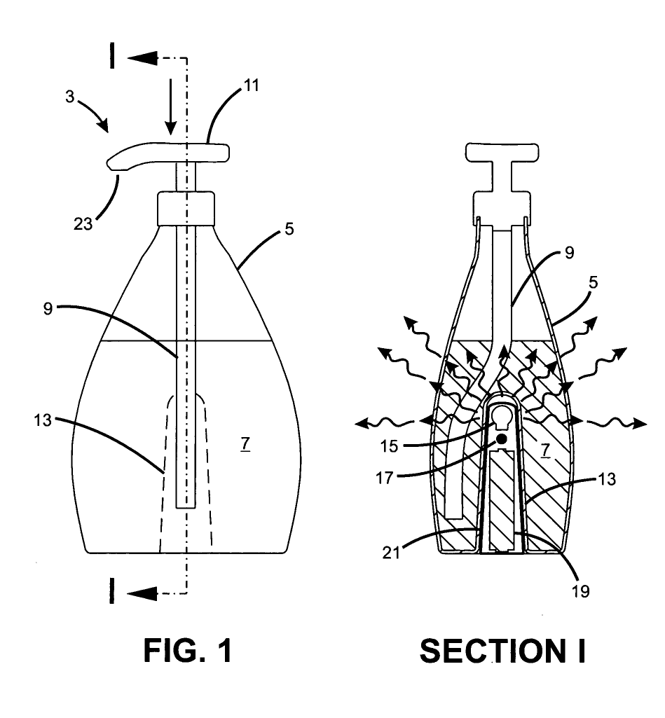

FIG. 1 shows an illuminated liquid dispenser 3 according to one embodiment of the invention. The dispenser is comprised of a translucent body 5 containing a quantity of translucent liquid 7, a dispensing means such as a plunger pump 11 with a nozzle 23, a soap stem 9, and a light apparatus compartment 13. In some embodiments, the liquid may be, for example, translucent liquid soap. The liquid soap may be antibacterial in nature, or a simple conventional liquid soap. In general the liquid soap is translucent and allows passage of light through its volume. In some embodiments, the soap or other such liquid may include small decorative elements such as particles of glitter or the like. The body may be fully transparent and colorless in order to economize on the packaging by using several colors of soap. The translucent body may, in some embodiments, be formed of plastic or glass. When pressed, the plunger pumps a quantity of liquid soap through the stem and dispenses it at the plunger nozzle.

Section I is a section view of FIG. 1. The dispenser body 5 contains a quantity of liquid soap. In addition the light apparatus compartment 13 may, in some embodiments, be integrally formed as part of the body of the dispenser during manufacturing. Typically this type of container is formed via blow molding, and the light compartment would be formed directly by a feature in the molding apparatus. The stem 9 may, in some embodiments, be flexible. The stem is shown in a diverted position from the light compartment. A stem might typically be made of polypropylene, however there is no specific material limitation according to the invention.

The light apparatus compartment contains a light module housing 21, which further contains a power source 19, a switching component 17 and at least one light emitting component 15. The light module housing is made of a transparent or translucent material and may be sealed by an O-ring or ultrasonic weld (not shown). In some embodiments, the light apparatus does not require a housing, and the bulb or LED may be directly exposed to the exterior surface of the container body. The switching component may be a light-sensing component, such that the light source 15 may be activated when low ambient light is sensed. It should be noted that the switch could also be manual, sound or motion activated or the like. The power source may be a battery or any other source of electrical energy sufficient to drive the light source. In some embodiments, the electrical energy is provided externally e.g. from a wall socket. The light source may be an incandescent bulb or a white LED for example. A plurality of light sources is possible as well. Details of wiring are excluded for clarity and because they are straightforward for one skilled in the art.

The apparatus may function as a night light in a bathroom, providing the user with a convenient means of locating the soap dispenser without activating brighter lights. This may be particularly desirable late at night.

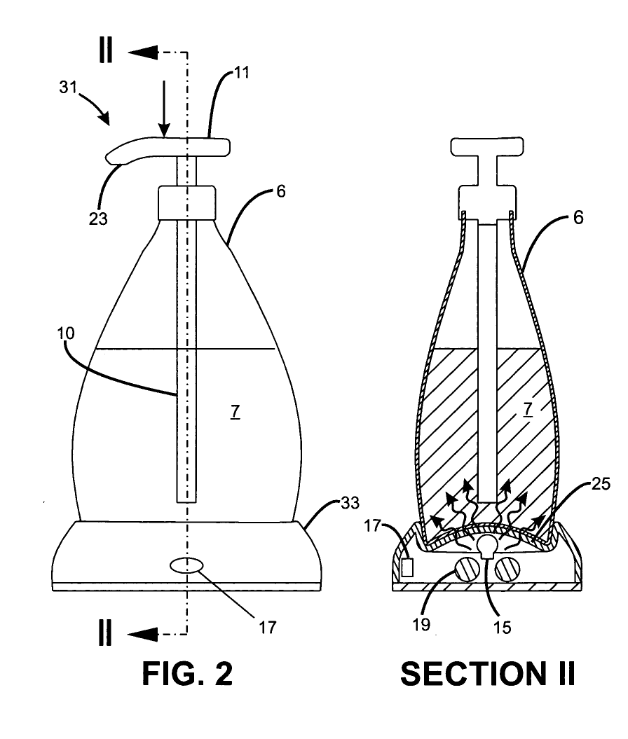

FIG. 2 shows another embodiment of an illuminated liquid soap dispensing apparatus 31 according to the invention. The dispenser is comprised of a translucent body 6 containing a quantity of translucent liquid soap 7, a plastic plunger pump 11 with a nozzle 23, a plastic soap stem 10 and a light-emitting base 33 with a switching component 17.

Section II is a section view of FIG. 2. The dispenser body 5 contains a quantity of liquid soap 7. The dispenser body 5 rests on a base 33 which houses an electrical power source 19, at least one light emitting component, and a switching component 17 for controlling the state of the light component. Additionally the base may include a translucent region 25 for the purpose of providing light transmission from the base to the soap dispenser body. The switching component may be a light-sensing component, such that the light source 15 may be activated when low ambient light is sensed. The switch could also be manual, sound or motion activated or the like. The power source may be a battery or any other source of electrical energy sufficient to drive the light source. The light source may be an incandescent bulb or a white LED for example. A plurality of light sources is possible as well. Details of wiring are excluded for clarity and because they are straightforward for one skilled in the art.

The dispenser body may be affixed to the base as an assembly, or as a separate component. It may be desirable to market base illuminators for an existing product line of liquid soap, so in that case the base would be manufactured and sold independently. The end user then configures the invention in their home when assembling the dispenser to the base. The base may be made of a variety of materials such as plastic, ceramic, glass or metal. There is no specific material requirement for the base except that there may be a region of translucent material (if any) at the location between the light emitting device and the dispenser bottom.

The apparatus may function as a night light in a bathroom or kitchen, providing the user with a convenient means of locating the soap dispenser without activating brighter lights. This may be particularly desirable late at night.

The various components shown in the FIGS. are not necessarily shown to scale. Sizing the various components is well within the abilities of an ordinary skilled designer, when armed with the teachings of this disclosure. For example, dispensers in a bathroom may be smaller than those for a kitchen. In such cases the designer may opt for different materials, power sources and light sources for each case. Such material choices will have manufacturing tradeoffs that will affect the sizing decisions, but this process is well within the scope of one skilled in the art of product design and manufacturing.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The various features illustrated in the figures may be combined in many ways, and should not be interpreted as though limited to the specific embodiments in which they were explained and shown.

Those skilled in the art having the benefit of this disclosure will appreciate that many other variations from the foregoing description and drawings may be made within the scope of the present invention. Indeed, the invention is not limited to the details described above.

1. An apparatus comprising:
a translucent body for containing a quantity of translucent liquid soap;
a housing coupled to the translucent body; and
a light emitting apparatus coupled to the housing for providing light;
whereby when the light emitting apparatus is operating, light passes from it through the translucent body and translucent soap.

2. The apparatus of claim 1 wherein the housing is integrally formed with the translucent body.

3. The apparatus of claim 2 wherein the housing comprises a light module housing disposed within a compartment which extends into the translucent body.

4. The apparatus of claim 1 wherein:
the housing comprises a base; and
the translucent body comprises a container which can be removed from the base.

5. The apparatus of claim 1 further comprising:
a switch coupled to control operation of the light emitting apparatus.

6. The apparatus of claim 5 wherein the switch activates in response to a low ambient light condition, such that the apparatus comprises a night light.

7. The apparatus of claim 5 wherein the switch activates in response to sound.

8. The apparatus of claim 5 wherein the switch activates in response to motion.

9. The apparatus of claim 5 wherein the switch comprises a manually operated switch.

10. The apparatus of claim 1 further comprising:
a pump coupled to and extending into the translucent body for extracting the translucent liquid soap.

11. The apparatus of claim 1 further comprising:
the translucent liquid soap disposed within the translucent body.

12. The apparatus of claim 1 wherein the light emitting apparatus comprises an incandescent bulb.

13. The apparatus of claim 1 wherein the light emitting apparatus comprises a light emitting diode.

14. The apparatus of claim 1 further comprising:
means for providing electricity to the light emitting apparatus.

15. The apparatus of claim 14 wherein the means for providing electricity comprises a battery.

16. A dispenser for dispensing a liquid, the dispenser comprising:
a translucent container body for holding the liquid;
means, coupled to the translucent container body, for dispensing the liquid; and
means, coupled to the translucent container body, for emitting light to shine through the translucent container body.

17. The dispenser of claim 16 wherein:
the means for emitting light includes a base; and
the translucent container body and the means for dispensing are removable from the base.

18. The dispenser of claim 16 further comprising:
a quantity of liquid disposed within the translucent container body.

19. A night light comprising:
a translucent container body for holding a quantity of translucent liquid soap;
a pump coupled to the translucent container body for dispensing the translucent liquid soap; and
a light emitting apparatus coupled to the translucent container body so as to shine light through the translucent liquid soap and thence away from the night light.

20. The night light of claim 19 further comprising:
means for activating the light emitting apparatus in response to a low ambient light condition.
